(19) United States
(12) Patent Application Publication
(10) Pub. No.: US 2008/0002041 A1
(43) Pub. Date: Jan. 3, 2008

(54) ADAPTIVE IMAGE ACQUISITION SYSTEM AND METHOD

(76) Inventors: Charles Chia-ming Chuang, Shanghai (CN); Qing Guo, Shanghai (CN); John Dick Gilbert, Applegate, OR (US)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/734,276

(22) Filed: Apr. 12, 2007

Related U.S. Application Data
(63) Continuation-in-part of application No. 11/164,814, filed on Dec. 6, 2005.
(60) Provisional application No. 60/706,703, filed on Aug. 8, 2005.

(51) Int. Cl. H04N 5/217

(52) U.S. Cl. 348/241; 348/E05.024

(57) ABSTRACT

A system and method for correcting optical distortions on an image acquisition system by scanning and mapping the image acquisition system and adjusting the content of output pixels. The optical distortion correction can be performed either at the camera end or at the display receiving end.

### PRIORITY REFERENCE TO PRIOR APPLICATIONS

This application is a continuation-in-part of and incorporates by reference U.S. patent application Ser. No. 11/164,814, entitled “IMAGE ADAPTATION SYSTEM AND METHOD,” filed on Dec. 6, 2005, by inventor John Dick GILBERT, which claims benefit of U.S. Patent Application No. 60/706,703 filed Aug. 8, 2005 by inventor John Gilbert, which is also incorporated by reference.

### FIELD OF THE INVENTION

The present invention relates to image acquisition system and, in particular, but not exclusively, provides a system and method for adapting an output image to a high resolution still camera or a video camera.

### BACKGROUND OF THE INVENTION

Rapid advancement in high resolution sensors, based on either charged couple device (CCD) or complimentary metal oxide semiconductor (CMOS) technology, has made digital still camera and video recorders popular and affordable. The sensor technology follows the long standing semiconductor trend of increasing density and reducing cost at a very rapid pace. However, the cost of digital still camera and the video recorders do not follow the same steep curve. The reason is the optical system used in the image acquisition systems has become the bottleneck both in performance and in cost. A typical variable focus and variable zoom optical system has more than a dozen lenses. As the image pixel increases from closed circuit television (CCTV) camera resolution of 656 horizontal lines to 10 mega-pixel digital still camera of 2500 horizontal lines and up, and the pixel resolution migrating from 8 bits to 10 bits to 12 bits, the precision of optical components, and the precision of the optical system assembly must be improved and the optical distortions minimized. However, the optical technology does not evolve as fast as the semiconductor technology. Precision optical parts with tight tolerances, especially the aspheric lenses, are expensive to make. The optical surface requirement is now at 10 micro meters or better. As the optical components are assembled to form the optical system, the tolerances stack up. It is very hard to keep focus, spherical aberration, centering, chromatic aberrations, astigmatism, distortion, and color convergence within a tight tolerance even after very careful assembly process. Optical subsystem cost of an image acquisition product is increasing even though the sensor cost is falling. Clearly the traditional, pure optical approach cannot solve this problem.

It is desirable to have very wide angle lenses. A person attempting to take a self portrait through a cell phone camera does not have to extend his/her arm as far. The high resolution CCD or CMOS sensors are available and cost effective. A high resolution sensor coupled with a very wide angle lens system can cover the same surveillance target as multiple, standard low resolution cameras. It is much more cost effective, in installation, operation, and maintenance, to have few high resolution cameras instead of many low resolution cameras. However, standard pure optical approach to design and manufacture wide angle lens is very difficult. It is well known that geometry distortion of a lens increases as the field of view expands. A general rule of thumb has the geometry distortion increases at the seventh power of the field of view angle. This is the reason why most digital still camera do not have wide angle lens, and available wide angle lens are either very expensive, or have very large distortions. The fish-eye lens is a well know subset of wide angle lenses.

It is known in prior art that general formula for optical system geometry distortion approximation can be used for correction. Either through warp table generation or fixed algorithms on the fly, the lens distortion can be corrected to a certain degree. However, the general formula cannot achieve consistent quality due to lens manufacturing tolerances. The general formula also cannot capture the optical distortion signature unique to each image acquisition system. The general formula, such as parametric class of warping functions, polynomial functions, or scaling functions, can also be computationally intensive, must use expensive hardware for real time correction. Therefore, a new system and method is needed that can efficiently and cost effectively corrects for optical distortions in image acquisition systems.

### SUMMARY OF THE INVENTION

An object of the present invention is, therefore, to provide an image acquisition system with adaptive means to correct for optical distortions, including geometry and brightness and contrast variations in real time.

Another object of the present invention is to provide an image acquisition system with adaptive methods to correct for optical distortion in real time.

A further object of this invention is to provide a method of video content authentication based on the video geometry and brightness and contrast correction data secured in the adaptive process.

Embodiments of the invention provide a system and method that enables the inexpensive altering of video content to correction for optical distortions in real-time. Embodiments do not require a frame buffer and there is no frame delay. Embodiments operate at the pixel clock rate and can be described as a pipeline for that reason. For every pixel in-there is a pixel out.

Embodiments of the invention work for up-sampling or down-sampling uniformly well. It does not assume a uniform spatial distribution of output pixels. Further, embodiments use only one significant mathematical operation, a divide. It does not use complex and expensive floating point calculations as do conventional image adaptation systems.

In an embodiment of the invention, the method comprises: placing a test target in front of the camera, acquiring output pixel centroids for a plurality of output pixels; determining adjacent output pixels of a first output pixel from the plurality; determining an overlay of the first output pixel over virtual pixels corresponding to an input video based on the acquired output pixel centroids and the adjacent output pixels; determining content of the first output pixel based on content of the overlaid virtual pixels; and outputting the determined content to a display device.

In an embodiment of the invention, the system comprises an output pixel centroids engine, an adjacent output pixel engine communicatively coupled to the output pixel centroids engine, and output pixel overlay engine communicatively coupled to the adjacent output pixel engine, and an output pixel content engine communicatively coupled to the output pixel overlay engine. The adjacent output pixel engine determines adjacent output pixels of a first output pixel from the plurality. The output pixel overlay engine determines an overlay of the first output pixel over virtual pixels corresponding to an input video based on the acquired output pixel centroids and the adjacent output pixels. The output pixel content engine determines content of the first output pixel based on content of the overlaid virtual pixels and outputs the determined content to a video display device.

In another embodiment of the invention, the method comprises: placing a test target in front of the camera, acquiring output pixel centroids for a plurality of output pixels. Embed the output pixel centroids data and brightness and contrast uniformity data within the video stream and transmit to a video display device. The pixel correction process is then executed at the video display device end. In a variation of the invention, for a video display device having similar adaptive method, the pixel centroids data and brightness uniformity data of the camera can be merged with the pixel centroids data and brightness uniformity data of the display output device, using only one set of hardware to perform the operation.

The foregoing and other features and advantages of preferred embodiments of the present invention will be more readily apparent from the following detailed description, which proceeds with reference to the accompanying drawings.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a prior art video image acquisition system;

FIG. 2A is a block diagram illustrating an adaptive image acquisition system according to an embodiment of the invention;

FIG. 2B is a block diagram illustrating an adaptive image acquisition system according to another embodiment of the invention;

FIG. 3A is an image taken from a prior art image acquisition system;

FIG. 3B is an image taken with wide angle adaptive image acquisition system;

FIG. 4A shows the checker board pattern in front of a light box used for geometry and brightness correction;

FIG. 4B shows the relative position of the camera in the calibration process;

FIG. 4C shows a typical calibration setting where the checker board pattern positioning is not exactly perpendicular to the camera;

FIG. 5A shows the barrel effect exhibited by a typical camera/lens system;

FIG. 5B shows the brightness fall off exhibited by a typical camera/lens system;

FIG. 6 shows a representation of 4-pixel video data having red, green and blue contents, each having 8-bits;

FIG. 7 shows a representation of 4-pixel video data having red, green and blue contents, each having 8 bits, and additional two bit planes for the storage of brightness and contrast correction and geometry correction data;

FIG. 8 shows a block diagram illustrating an image processor;

FIG. 9 shows a greatly defocused image of the checker board pattern and a graphical method of determining the intersection between two diagonally disposed black squares;

FIG. 10 is a diagram illustrating the distorted image area and the corrected, no distortion display area;

FIG. 11 is a diagram illustrating mapping of output pixels onto a virtual pixel grid of the image;

FIG. 12 is a diagram illustrating centroid input from the calibration process;

FIG. 13 is a diagram illustrating an output pixel corner calculation;

FIG. 14 is a diagram illustrating pixel sub-division overlay approximation;

FIG. 15 is a flowchart illustrating a method of adapting for optical distortions; and

FIG. 16 is a diagram illustrating mapping of display output pixels onto a virtual pixel grid of the display, then remapped to the virtual pixel grid of the image capture device.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

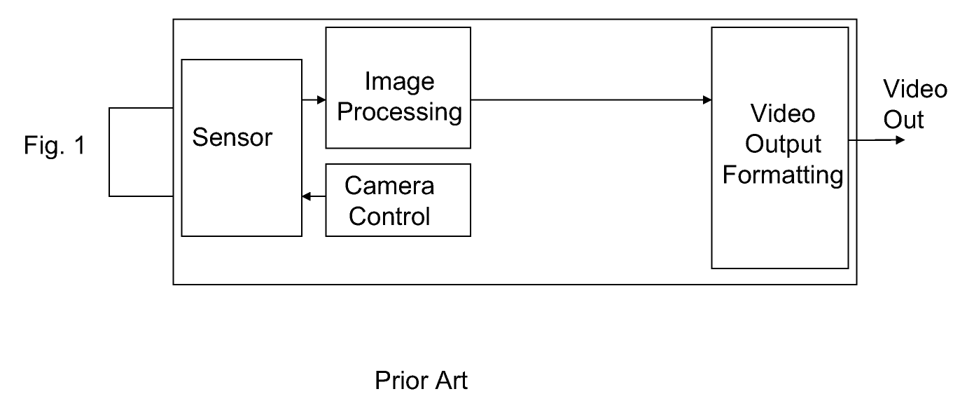

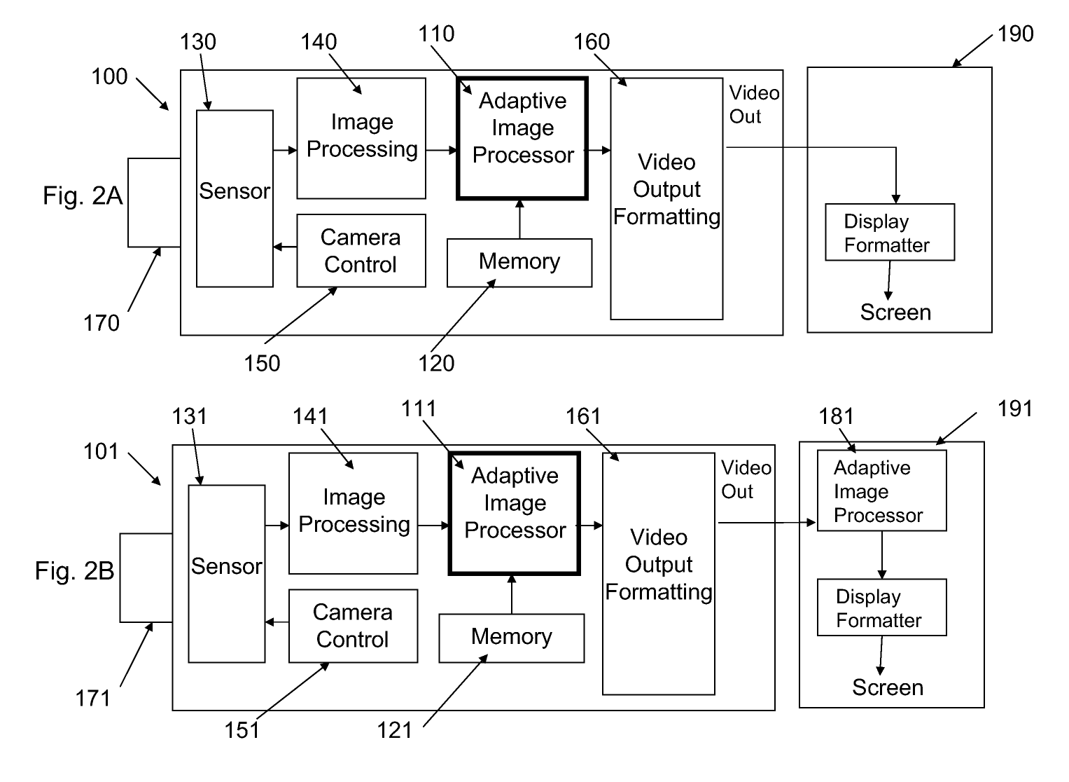

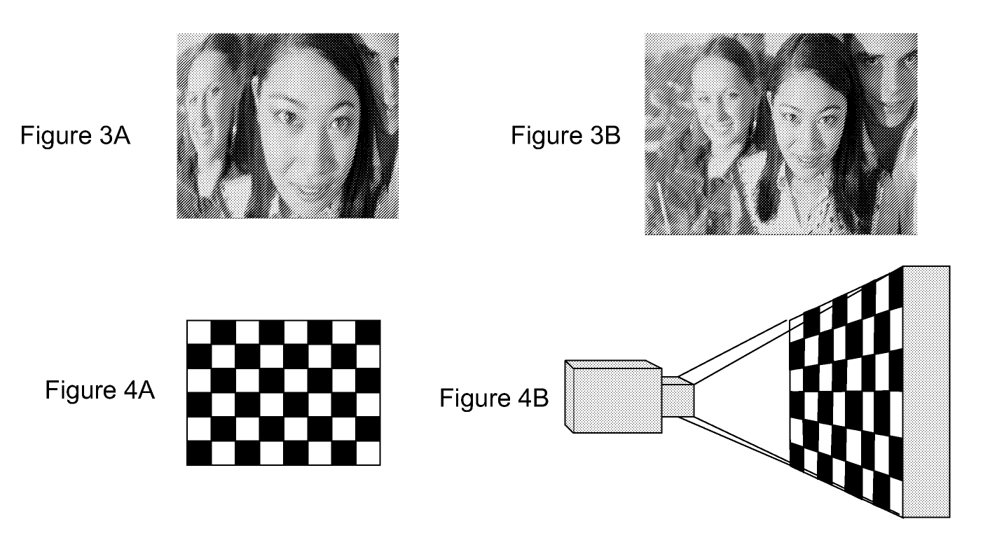

FIG. 1 is a block diagram of a conventional camera. FIG. 2A is a block diagram illustrating an adaptive image acquisition system 100 according to an embodiment of the invention. Every image acquisition system has a sensor 130 for capturing images. Typical sensors are CCD or CMOS 2-dimensional sensor arrays found in digital cameras. Line scan camera and image scanners use one-dimensional sensor array with optical lens, and also subject to optical distortions. Other image sensors such as infrared, ultra-violet, or X-ray may not be visible to the naked eye, but have their own optical lens systems and have optical distortions that can benefit from embodiments of the current invention. There is an optical lens system 170 in front of the sensors in order to collect light rays emanated or reflected from images and correctly focus them onto the sensor array 130 for collection. There is typically a camera control circuit 150 to change the shutter speed or the iris opening in order to optimize the image capture. The output of the image sensors typically requires white balance correction, gamma correction, color processing, and various other manipulations to shape them into a fair representation of the images captured. The image processing 140 is typically done with an ASIC, but can also be performed by a microprocessor or a microcontroller that has image processing capabilities. According to an embodiment of this invention, an adaptive image processor 110 is then used to apply optical distortion correction and brightness and contrast correction to the images before sending them out. This image adaptation invention is fast enough for real time continuous image processing, or video processing. Therefore, in this patent application, image processing and video processing is used interchangeably, and image output and video output is also used interchangeably. A memory block 120 communicatively coupled to the adaptive image processor 110 is used to store the adaptive parameters for geometry and brightness corrections. In order to minimize memory storage, these parameters can be compressed first, then rely on the adaptive image processor to do the decompression before application. The processed image is packaged by output formatter 160 into different output formats before they are shipped to the outside world. For NTSC, a typical analog transmission standard, the processed image is encoded into the proper analog format first. For Ethernet, the processed images are compressed via MPEG-2, MPEG-4, JPEG-2000, or various other commercially available compression algorithms first before formatting into Ethernet packets. And then the Ethernet packets are further packaged to fit the transmission protocols such as wireless 802.11a, 802.11b, 802.11g, or wired 100M Ethernet. The processed images can also be packaged for transmission on USB, Bluetooth, IEEE1394, Irda, HomePNA, HDMI, or other commercially available video transfer protocol standards. Video output from the image acquisition system is fed into a typical display device 190, where the image is further formatted for specific display output device, such as CRT, LCD, or projection before it is physically shown on the screen.

[Camera Calibration]

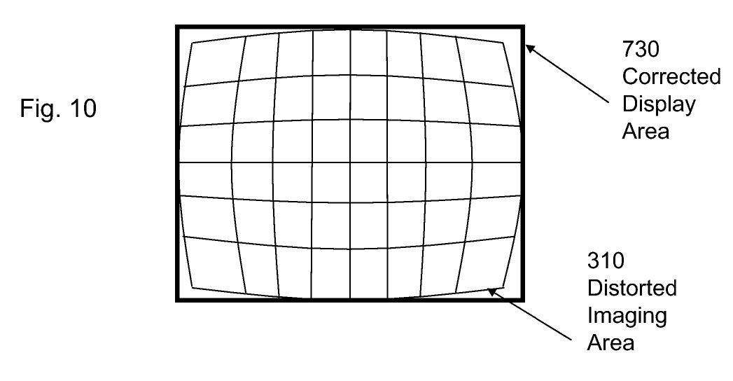

A typical captured image may exhibit barrel distortions as shown in FIG. 10. By imaging a checker board pattern, the centroids of the checker board intersections of the white and black blocks can be computed across the entire image space, the brightness of each block can be measured, and the resulting geometry and brightness/contrast distortion map is essentially a “finger print” of a specific image acquisition system, taking into account the distortions from lens imperfections, assembly tolerances, coating differences on the substrate, passivation differences on the sensors and other fabrication/assembly induced errors. The distortion centroids can be collected three times; one for red, one for green, and one for blue in order to properly adjusted for lateral color distortion, since light wavelength does affect the degree of distortions through an optical system.

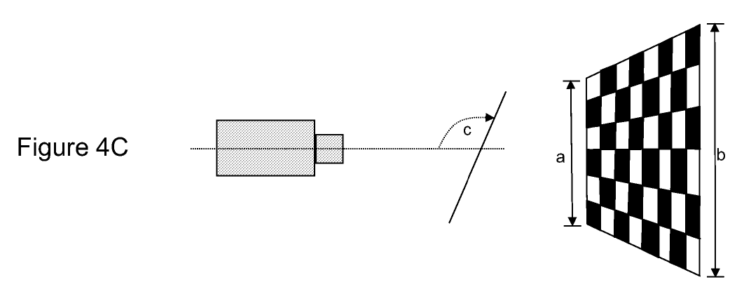

A checker board pattern test target with a width of 25 inches shown in FIG. 4A can be fabricated with photolithography to a good precision. Accuracy of 10 micro-inches over a width of 25 inch total width is commercially available, which will give a dimensional accuracy of 0.00004%. For a 10 mega pixel camera with a linear dimension of 2500 pixels, the checker board accuracy can be expressed as 0.1% of a pixel. As shown in FIG. 4C, the checker board test pattern does not have to be positioned exactly perpendicular to the camera. Offset angles can be calculated from the two sides a/b directly with great accuracy and the camera offset angle removed from the calibration error. There is no requirement for precision mechanical alignment in the calibration process. There is also no need for target (calibration plate) movement in the calibration process. Camera calibration accuracy can achieve about ¼ to 0.1 pixel using typical cross shaped or isolated squares fudicial patterns.

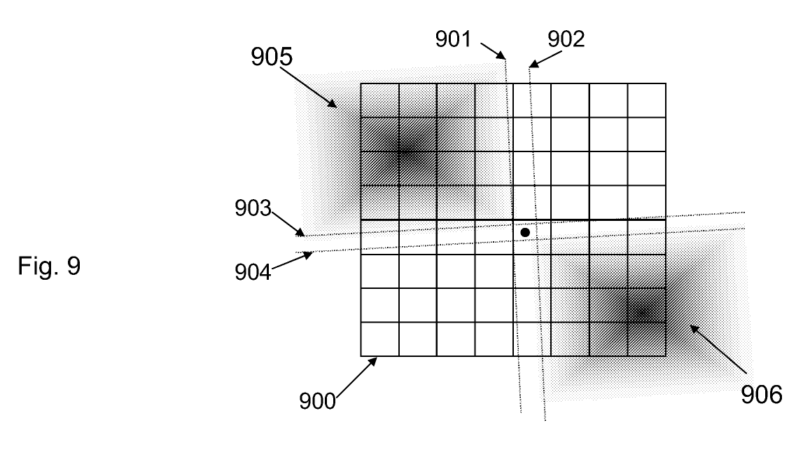

The checker board pattern, where black squares and white squares intersect, can be used to achieve a greater precision. FIG. 9 shows a greatly defocused picture of the checker board pattern as captured by a camera under calibration and a graphical method of determining the intersection between two diagonally disposed black squares 905, and 906. The sensor array 900 is superimposed on the image collected. Line 901 is the right side edge of block 905. This edge can be determined either by calculating for the inflection point of the white to black transition, or by calculating the mid point between the white to black transition using linear extrapolation. Line 902 is the left side edge of Block 906. In a clearly focused optical system, line 901 and line 902 should coincide. The key feature of the checker board pattern is that even with imperfect optical system, with imperfect iris optimization or focus optimization, with imperfection of aligning optical axis perpendicular to the calibration plate the vertical transition line can be precisely calculated as a line equal distance and parallel to line 901 and line 902. By the same token, line 903 is the lower side edge of the block 905, and line 904 is the upper side edge of the block 906. The edge of these two black blocks, 905 and 906, can be computed as the centroid of the square formed by lines 901, 902, 903, and 904 to a very precise manner. Camera calibration accuracy of 0.025 pixel or better can be achieved. This is the level of precision needed to characterize the optical distortion of the entire image capture system. The characteristics of optical distortion is a smooth varying function, so checker board patterns of 40 to 100 blocks in one linear dimension is good enough to characterize the distortion of a 10 mega pixel camera with 2500 pixels in one dimension. Test patterns similar in shape to a checker board have the similar effect. For example, diamond shaped checker board pattern also can be used.

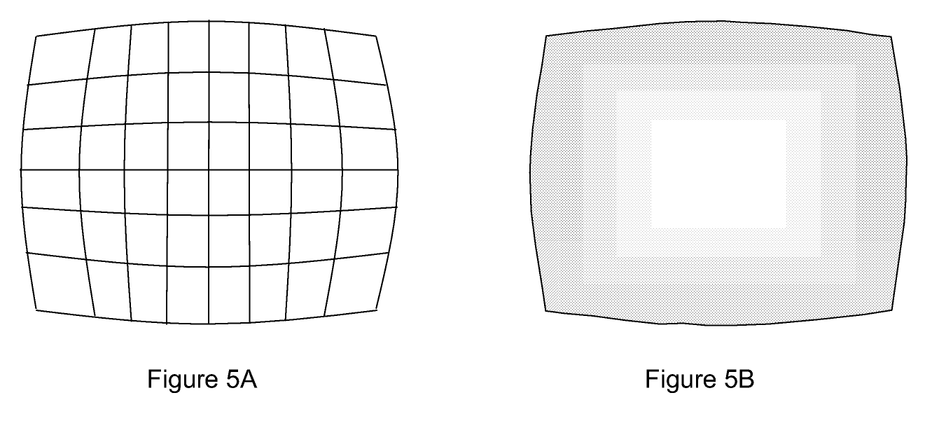

The checker board pattern test target can be fabricated on a Mylar film with black and transparent blocks using the same process for printed circuit boards. This test target can be mounted in front of a calibrated illumination source as shown in FIG. 4B. For brightness and contrast calibration, colorimetry on each black and white square on the checker board test pattern can be measured using precision instruments. An example of such instrument is a CS-100A calorimeter made by Konica Minolta Corporation of Japan. Typical commercial instruments can measure brightness tolerances down to 0.2%. A typical captured image may exhibit brightness gradients as shown in FIG. 5B. When compared with the luminance readings from an instrument, the brightness and contrast distortion map across the sensors can be recorded. This is a “finger print” or signature of a specific image acquisition system in a different dimension than the geometry.

[Embedding Signatures in Video Stream]

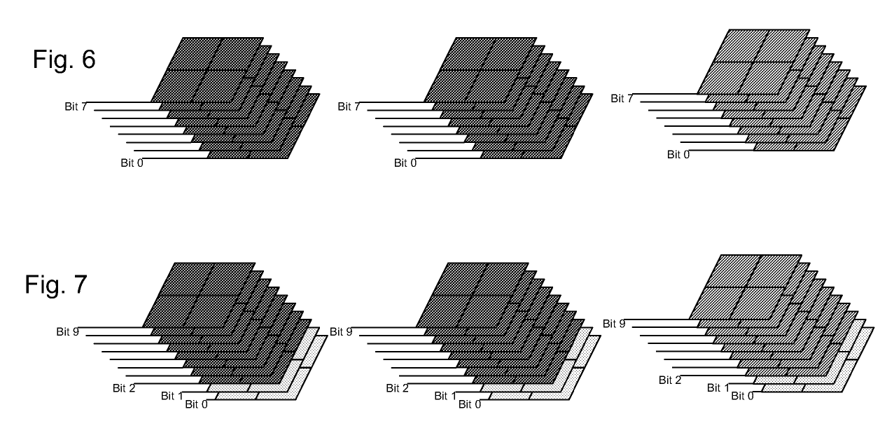

A preferred embodiment of the present invention is to embed signature information in the video stream, and to perform adaptive image correction at the display end. FIG. 2B is a block diagram illustrating this preferred embodiment. In this embodiment, the adaptive image processor 111 in the image acquisition device will embed signatures in the video stream, and an adaptive image processor 181 within a display 191 will perform the optical distortion correction. FIG. 6 shows a representation of 4 pixels video data having red, green and blue contents, each having 8 bits. One preferred embodiment for embedding optical distortion signatures for both geometry and/or brightness is shown in FIG. 7. Both signatures can be represented by the distortion differences with its neighbors, this method will cut down on the storage requirement. By inserting optical distortion signatures as brightness information as bottom two bits, the target display device, if not capable of performing optical distortion correction, will interpret them as video data of very low intensity, and the embedded signature will not be very visible on the display device. For display device capable of performing optical distortion correction, it will transform the video back to virtually no distortions in both geometry and brightness dimensions. For security application, this is significant since object recognition can be performed more accurately and faster if all video images have no distortions. If the video information is transmitted without correction, it is also very difficult to tamper with, since both geometry and brightness will be changed before display, and any data modifications on the pre-corrected data will not fit the signature of the original image acquisition device and will stand out. For a still camera device, the entire optical signature must be embedded within each picture, or have been transmitted once before as the signature of that specific camera. For continuous video, the optical signature in its entirety does not have to be transmitted all at once. There are many ways to break up the signatures to be transmitted over several video frames. There are also many methods to encode the optical signatures to make them even more difficult to be reversed.

[Video Compression Before Transmission]

Prior art standard compression algorithm can be used before transmission. For lossy compression, care has to be taken to ensure that optical signature is not corrupted in the compression process.

[Optical Distortion Correction]

Using the optical signatures in both geometry and brightness dimensions, the video output can be corrected using the following method.

Specifically, the image processor 110, as will be discussed further below, maps an original input video frame to an output video frame by matching output pixels on a screen to virtual pixels that correspond with pixels of the original input video frame. The image processor 110 uses the memory 120 for storage of pixel centroid information and/or any operations that require temporary storage. The image processor 110 can be implemented as software or circuitry, such as an Application Specific Integrated Circuit (ASIC). The image processor 110 will be discussed in further detail below. The memory 120 can include Flash memory or other memory format. In an embodiment of the invention, the system 100 can include a plurality of image processors 110, one for each color (red, green, blue) and/or other content (e.g., brightness) that operate in parallel to adapt an image for output.

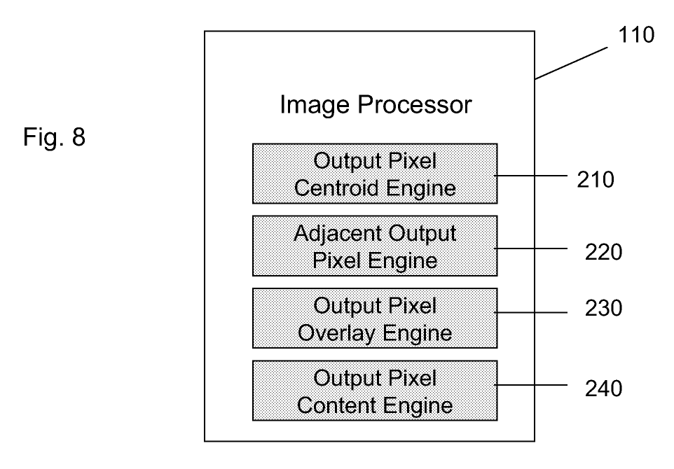

FIG. 8 is a block diagram illustrating the image processor 110 (in FIG. 2A). The image processor 110 comprises an output pixel centroid engine 210, an adjacent output pixel engine 220, an output pixel overlay engine 230, and an output pixel content engine 240. The output pixel centroid engine 210 reads out centroid locations into FIFO memories (e.g., internal to the image processor or elsewhere) corresponding to relevant lines of the input video. Only two lines plus three additional centroids need to be stored at a time, thereby further reducing memory requirements.

The adjacent output pixel engine 220 then determines which output pixels are diagonally adjacent to the output pixel of interest by looking at diagonal adjacent output pixel memory locations in the FIFOs. The output pixel overlay engine 230, as will be discussed further below, then determines which virtual pixels are overlaid by the output pixel. The output pixel content engine 240, as will be discussed further below, then determines the content (e.g., color, brightness, etc.) of the output pixel based on the content of the overlaid virtual pixels.

FIG. 10 is a diagram illustrating a corrected display area 730 and the video display of a camera prior to geometry correction 310. Before geometry correction, the camera output with wide angle lens typically shows barrel distortion, taking up less of the display area than the corrected ones. The corrected viewing area 730 (also referred to herein as virtual pixel grid) comprises an x by y array of virtual pixels that correspond to an input video frame (e.g., each line has x virtual pixels and there are y lines per frame). The virtual pixels of the corrected viewing area 730 correspond exactly with the input video frame. In an embodiment of the invention, the viewing area can have a 16:9 aspect ratio with 1280 by 720 pixels or a 4:3 ratio with 640 by 480 pixels.

Within the optically Distorted Display Area of the screen 310, the number of actual output pixels matches that of the output resolution. Within the viewing area 730, the number of virtual pixels matches the input resolution, i.e., the resolution of the input video frame, i.e., there is a 1:1 correspondence of virtual pixels to pixels of the input video frame. There may not be a 1:1 correspondence of virtual pixels to output pixels however. For example, at the corner of the viewing area 730, there may have several virtual pixels for every output pixel and at the center of the viewing area 730 there may be a 1:1 correspondence (or less) of virtual pixels to output pixels. Further, the spatial location and size of output pixels differs from virtual pixels in a non-linear fashion. Embodiments of the invention have the virtual pixels look like the input video by mapping of the actual output pixels to the virtual pixels. This mapping is then used to resample the input video such that the display of the output pixels causes the virtual pixels to look identical to the input video pixels, i.e., to have the output video frame match the input video frame so as to view the same image.

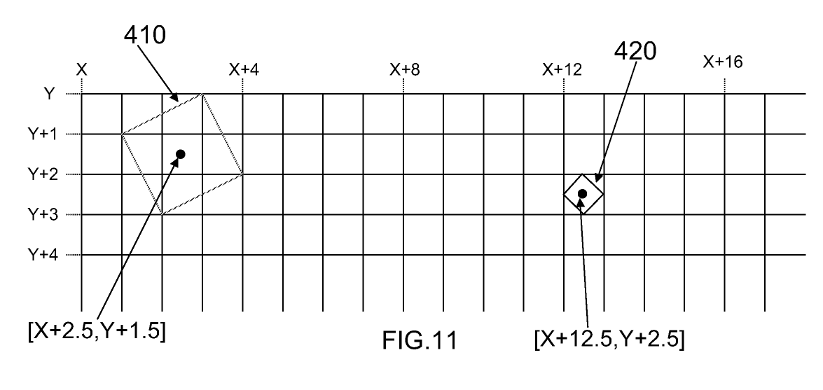

FIG. 11 is a diagram illustrating mapping of output pixels onto a virtual pixel grid 730 of the image 310. As embodiments of the invention enable output pixel content to create the virtual pixels viewed, the output pixel mapping is expressed in terms (or units) of virtual pixels. To do this, the virtual pixel array 730 can be considered a conceptual grid. The location of any output pixel within this grid 730 can be expressed in terms of horizontal and vertical grid coordinates.

Note that by locating an output pixel's center within the virtual pixel grid 730, the mapping description is independent of relative size differences, and can be specified to any amount of precision. For example, a first output pixel 410 is about four times as large as a second output pixel 420. The first output pixel 410 mapping description can be x+2.5, y+1.5, which corresponds to the center of the first output pixel 410. Similarly, the mapping description of the output pixel 420 can be x+12.5, y+2.5.

This is all the information that the output pixel centroid engine 210 need communicate to the other engines, and it can be stored in lookup-table form or other format (e.g., linked list, etc.) in the memory 120 and outputted to a FIFO for further processing. All other information required for image adaptation can be derived, or is obtained from the video content, as will be explained in further detail below.

At first glance, the amount of information needed to locate output pixels within the virtual grid appears large. For example, if the virtual resolution is 1280×720, approximately 24 bits is needed to fully track each output pixel centroid. But, the scheme easily lends itself to significant compaction (e.g. one method might be to fully locate the first pixel in each output line, and then locate the rest via incremental change).

In an embodiment of the invention, the operation to determine pixel centroids performed by the imaging device can provide a separate guide for each pixel color. This allows for lateral color correction during the image adaptation.

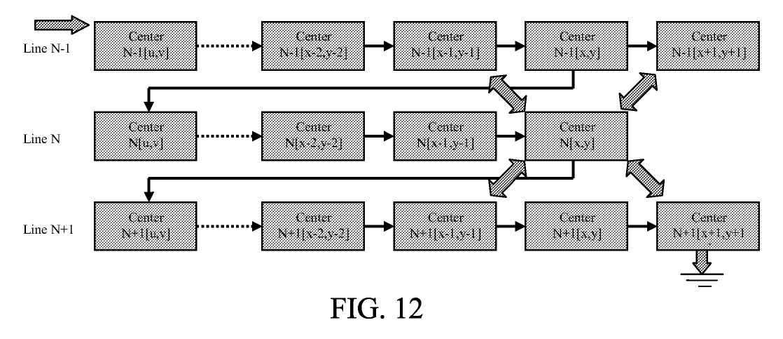

FIG. 12 is a diagram illustrating centroid input from the calibration process. Centroid acquisition is performed real-time—each centroid being retrieved in a pre-calculated format from external storage, e.g., from the memory 120.

Conceptually, as centroids are acquired by the output pixel centroid engine 210, the engine 210 stores the centroids in a set of line buffers. These line buffers also represent a continuous FIFO (with special insertions for boundary conditions), with each incoming centroid entering at the start of the first FIFO, and looping from the end of each FIFO to the start of the subsequent one.

The purpose of the line buffer oriented centroid FIFOs is to facilitate simple location of adjacent centroids for corner determination by the adjacent output pixel engine 220. With the addition of an extra ‘corner holder’ element off the end of line buffers preceding and succeeding the line being operated on, corner centroids are always found in the same FIFO locations relative to the centroid being acted upon.

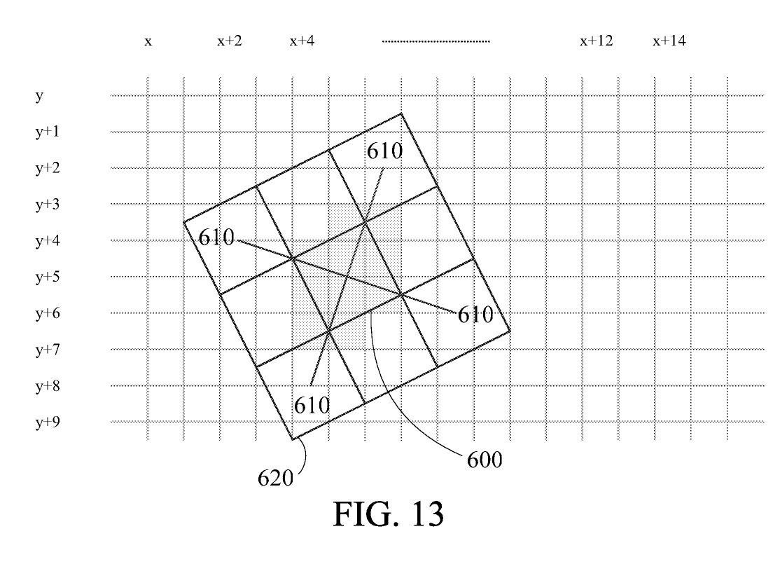

FIG. 13 is a diagram illustrating an output pixel corner calculation. Embodiments of the image adaptation system and method are dependent on a few assumptions:
Output pixel size and shape differences do not vary significantly between adjacent pixels.
Output pixels do not offset in the ‘x’ or ‘y’ directions significantly between adjacent pixels.
Output pixel size and content coverage can be sufficiently approximated by quadrilaterals.
Output quadrilateral estimations can abut each other.

These assumptions are generally true in a rear projection television.

If the above assumptions are made, then the corner points for any output pixel quadrilateral approximation (in terms of the virtual pixel grid 310) can be calculated by the adjacent output pixel engine 220 on the fly as each output pixel is prepared for content. This is accomplished by locating the halfway point 610 to the centers of all diagonal output pixels, e.g., the output pixel 620.

Once the corners are established, the overlap with virtual pixels is established by the output pixel overlay engine 230. This in turn creates a direct (identical) overlap with the video input.

Note that in the above instance the output pixel quadrilateral approximation covers many virtual pixels, but it could be small enough to lie entirely within a virtual pixel, as well, e.g., the output pixel 420 (FIG. 11) lies entirely within a virtual pixel.

Note also that in order to pipeline processing, each upcoming output pixel's approximation corners could be calculated one or more pixel clocks ahead by the adjacent output pixel engine 220.

Once the spatial relationship of output pixels to virtual pixels is established, content determination can be calculated by the output pixel content engine 240 using well-established re-sampling techniques.

Variations in output pixel size/density across the viewing area 310 mean some regions will be up-sampled, and others down-sampled. This may require addition of filtering functions (e.g. smoothing, etc.). The filtering needed is dependent on the degree of optical distortion.

The optical distortions introduced also provide some unique opportunities for improving the re-sampling. For example, in some regions of the screen 730, the output pixels will be sparse relative to the virtual pixels, while in others the relationship will be the other way around. This means that variations on the re-sampling algorithm(s) chosen are possible.

The information is also present to easily calculate the actual area an output pixel covers within each virtual pixel (since the corners are known). Variations of the re-sampling algorithm(s) used could include weightings by ‘virtual’ pixel partial area coverage, as will be discussed further below.

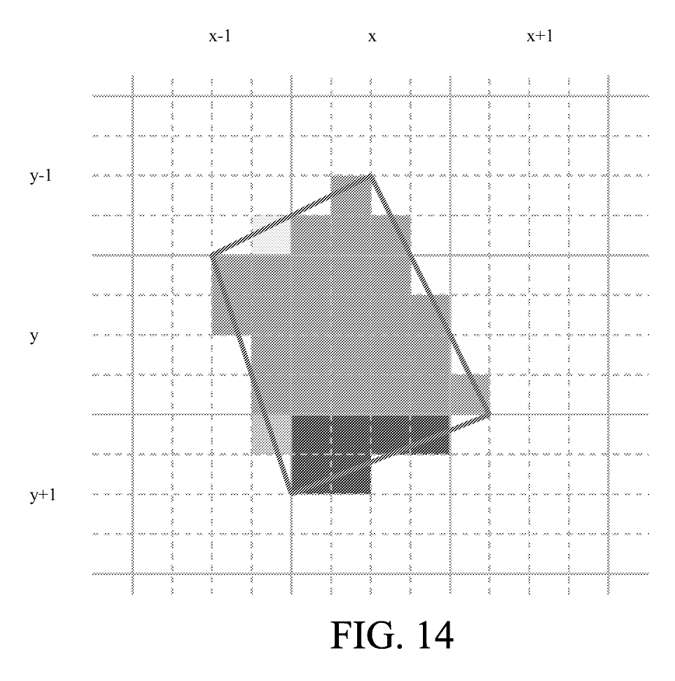

FIG. 14 is a diagram illustrating pixel sub-division overlay approximation. As noted earlier, one possible algorithm for determining content is to approximate the area covered by an output pixel across applicable virtual pixels, calculating the content value of the output pixel based on weighted values associated with each virtual pixel overlap.

However, calculating percentage overlap accurately in hardware requires significant speed and processing power. This is at odds with the low-cost hardware implementations required for projection televisions.

In order to simplify hardware implementation, the output pixel overlay engine 230 determines overlap through finite sub-division of the virtual pixel grid 310 (e.g., into a four by four subgrid, or any other sub-division, for each virtual pixel), and approximates the area covered by an output pixel by the number of sub-divisions overlaid.

Overlay calculations by the output pixel overlay engine 230 can be simplified by taking advantage of some sub-sampling properties, as follows:
All sub-division samples within the largest rectangle bounded by the output pixel quadrilateral approximation are in the overlay area.
All sub-division samples outside the smallest rectangle bounding the output pixel quadrilateral approximation are not in the overlay area.
A total of ½ the sub-division samples between the two bounding rectangles previously described is a valid approximation for the number within the overlay area.

The output pixel content engine 240 then determines the content of the output pixel by multiplying the content of each virtual pixel by the number of associated sub-divisions overlaid, adding the results together, and then dividing by the total number of overlaid sub-divisions. The output pixel content engine 240 than outputs the content determination to a light engine for displaying the content determination.

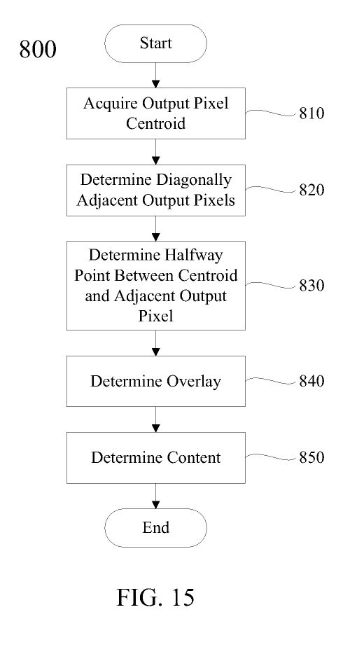

FIG. 15 is a flowchart illustrating a method 800 of adapting for optical distortions. In an embodiment of the invention, the image processor 110 implements the method 800. In an embodiment of the invention, the image processor 110 or a plurality of image processors 110 implement a plurality of instances of the method 800 (e.g., one for each color of red, green and blue). First, output pixel centroids are acquired (810) by reading them from memory into FIFOs (e.g., three rows maximum at a time). After the acquiring (810), the diagonally adjacent output pixels to an output pixel of interest are determined (820) by looking at the diagonally adjacent memory locations in the FIFOs. The halfway point between diagonally adjacent pixels and the pixel of interest is then determined (830). An overlay is then determined (840) of the output pixel over virtual pixels and output pixel content determined (850) based on the overlay. The determined output pixel content can then be outputted to a light engine for projection onto a display. The method 800 then repeats for additional output pixel until content for all output pixels are determined (850). Note that the pixel remapping process is a single pass process. Note also that the pixel remapping process does not require information on the location of the optical axis.

[Concatenate Adaptive Algorithms for Projection Displays]

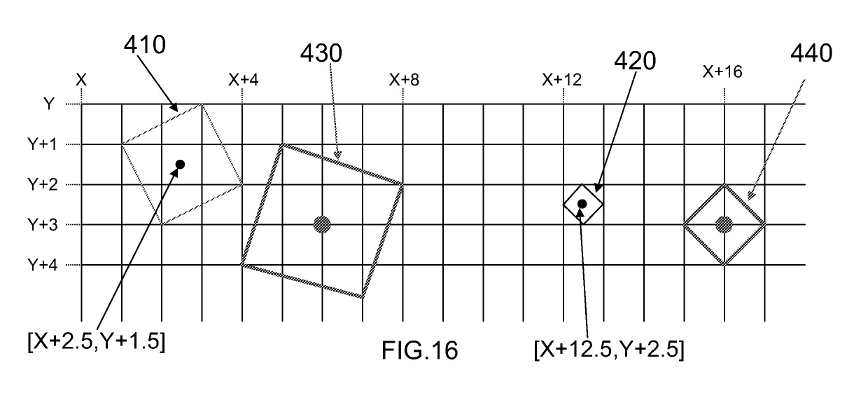

For flat panel displays using LCD or plasma technologies, there is no image geometry distortion from the display itself. This is not the case with projection displays. Projection optics will magnify an image from the digital light modulator 50-100 times for a typical 50″ or 60″ projection displays. The projection optics introduces focus, spherical aberration, chromatic aberrations, astigmatism, distortion, and color convergence errors the same way as the optics for image acquisition devices. Physical distortions will be different, but the centroid concept can be used. Therefore, it is possible to concatenate this centroid concept together in order to adaptively correct for image acquisition and display distortions in one pass. Taking point 420 in FIG. 16 as an example, it can incorporate display geometry correction of [X+3.5,Y+1.5] on top of the image acquisition geometry correction of [X+2.5,Y+1.5], and concatenate into [X+6,Y+3]. The final centroid is point 430. Concatenated centroid map can be computed ahead of time. By the same token, brightness and contrast distortion correction map can also be concatenated.

The foregoing description of the illustrated embodiments of the present invention is by way of example only, and other variations and modifications of the above-described embodiments and methods are possible in light of the foregoing teaching. For example, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method for acquiring an image, comprising:
acquiring output pixel centroids for a plurality of output pixels;
determining adjacent output pixels of a first output pixel from the plurality;
determining an overlay of the first output pixel over virtual pixels corresponding to an input image based on the acquired output pixel centroids and the adjacent output pixels;
determining content of the first output pixel based on content of the overlaid virtual pixels; and
outputting the determined content.

2. The method of claim 1, wherein the acquiring reads three rows of output pixel centroids into a memory.

3. The method of claim 2, wherein the determining adjacent output pixels determines diagonally adjacent output pixels.

4. The method of claim 3, wherein the determining diagonally adjacent output pixels comprises reading diagonally adjacent memory locations in the memory.

5. The method of claim 1, wherein determining the overlay comprises subdividing the virtual pixels into at least two by two sub-regions and determining the number of sub-regions from each virtual pixel that is overlaid by the output pixel.

6. The method of claim 1, wherein the determining content is for a single color.

7. The method of claim 6, wherein the determining content and the outputting are repeated for additional colors.

8. The method of claim 1, wherein the determining content uses adds and a divide.

9. The method of claim 1, wherein the method is operated as a pipeline.

10. The method of claim 1, further comprising embedding the overlay in the determined content as brightness information.

11. The method of claim 1, wherein the outputting further includes embedding an optical distortion signature for geometry or brightness into the output.

12. An image acquisition system, comprising:
an output pixel centroid engine capable of acquiring output pixel centroids for a plurality of output pixels;
an adjacent output pixel engine, communicatively coupled to the output pixel centroid engine, capable of determining adjacent output pixels of a first output pixel from the plurality;
an output pixel overlay engine, communicatively coupled to the adjacent output pixel engine, capable of determining an overlay of the first output pixel over virtual pixels corresponding to an input image based on the acquired output pixel centroids and the adjacent output pixels; and
an output pixel content engine, communicatively coupled to the output pixel overlay engine, capable of determining content of the first output pixel based on content of the overlaid virtual pixels and capable of outputting the determined content.

13. The system of claim 12, wherein the output pixel centroid engine acquires reading three rows of output pixel centroids into a memory.

14. The system of claim 13, wherein the adjacent output pixel engine determines adjacent output pixels by determining diagonally adjacent output pixels.

15. The system of claim 14, wherein the adjacent output pixel engine determines diagonally adjacent output pixels by reading diagonally adjacent memory locations in the memory.

16. The system of claim 12, wherein the output pixel overlay engine determines the overlay by subdividing the virtual pixels into at least two by two sub-regions and determining the number of sub-regions from each virtual pixel that is overlaid by the output pixel.

17. The system of claim 12, wherein the output pixel content engine determines content for a single color.

18. The system of claim 17, wherein the output pixel content engine determines content and outputs the determined content for additional colors.

19. The system of claim 12, wherein the output pixel content engine determines content using adds and a divide.

20. The system of claim 12, wherein the system is a pipeline system.

21. The system of claim 12, wherein the output pixel content engine embeds the overlay into the determined content as brightness information.

22. The system of claim 12, further comprising an adaptive image processor for embedding an optical distortion signature for geometry or brightness into the output.

23. An image acquisition system, comprising:
means for acquiring output pixel centroids for a plurality of output pixels;
means for determining adjacent output pixels of a first output pixel from the plurality;
means for determining an overlay of the first output pixel over virtual pixels corresponding to an input image based on the acquired output pixel centroids and the adjacent output pixels;
means for determining content of the first output pixel based on content of the overlaid virtual pixels; and
means for outputting the determined content.
